(19) United States
(12) Patent Application Publication
(10) Pub. No.: US 2018/0254574 A1
(43) Pub. Date: Sep. 6, 2018

(54) ELECTRICAL SOCKET WITH RETRACTABLE ELECTRICAL CONTACTS, INCLUDING A CLOSING DEVICE

(71) Applicant: GULPLUG, Grenoble (FR)

(72) Inventor: Sylvain Nicot, Grenoble (FR)

(21) Appl. No.: 15/759,322

(22) PCT Filed: Sep. 1, 2016
(86) PCT No.: PCT/FR2016/052166

§ 371 Date: Mar. 12, 2018

(30) Foreign Application Priority Data
Sep. 16, 2015 (FR) 1558712

(51) Int. Cl. H01R 13/453; H01R 13/62; H01R 13/08

(52) U.S. Cl. CPC H01R 13/453; H01R 24/66; H01R 13/08; H01R 13/6205

(57) ABSTRACT

The invention relates to an electrical socket (1) comprising:
a housing (10) comprising at least one first opening,
at least one mobile assembly comprising at least one first electrical contact, arranged to displace said first electrical contact through said first opening between a first position retracted inside the socket and a second position in which the first electrical contact is outside the socket,
a first device for closing said first opening comprising a first flap (160) and a second flap (161) arranged to close or open the first opening,
at least one driving system arranged to transform a translational movement of the mobile assembly into a rotational movement of the flaps of the closing device.

### TECHNICAL FIELD OF THE INVENTION

The present invention relates to an electrical socket assembly. The electrical socket assembly comprising a socket and an electrical plug intended to be matched to the socket.

### STATE OF THE ART

The patent application WO2012032230A1 describes an electrical socket assembly, a socket and an electrical plug intended to be matched to the socket. The plug comprises two electrical tracks intended to be connected electrically to two electrical contacts of the socket. The two electrical contacts have the particular feature of being displaced between a position retracted inside the socket and a position outside of the socket. When they are retracted inside the socket, they are therefore inaccessible, rendering the socket perfectly safe. When the plug is offered up to the socket, magnetic control means, comprising a permanent magnet incorporated in the plug and a mobile magnetic element housed in the socket and secured to the electrical contacts, allow the extraction of the electrical contacts from the socket and the connection thereof with the electrical tracks. When the plug is uncoupled from the socket, a spring-acting mechanical system repositions the mobile mechanism inside the socket.

To close the access to the electrical contacts when the latter are retracted inside the socket, it is known practice to employ flaps which are mobile between two positions.

The patent application WO2012/032230A1 thus describes a pivoting flaps mechanism present on the socket. Each flap is mounted to pivot on an axis independently and stressed by a spring. When the electrical contacts are displaced outside of the socket, the latter each push a flap against its spring. This solution exhibits several drawbacks:

a significant bulk, linked in particular to the positioning of the springs,

a risk of premature wear of the flaps, the latter being pushed directly by the electrical contacts.

For its part, the patent application FR2918216A1 describes a sliding flaps mechanism in which the movement of each electrical contact towards the outside of the socket drives a corresponding movement of an electrical flap. A spring, produced in the form of a flexible blade links each flap with an electrical contact. The translational movement of the electrical contact along an axis at right angles to the plane of coupling of the plug on the socket, is transformed into a translational movement of the flap on a plane parallel to said coupling plane. In this solution, the risk of premature wear of the flaps is avoided. However, it exhibits other drawbacks, including:

a significant bulk, linked to the clearance required for the translation of the flaps,

an unattractive appearance, the use of runners making it impossible to propose a socket with a perfectly flat front face,

an unsatisfactory reliability, linked to the use of runners, sources of malfunctions.

The aim of the invention is to propose a solution to prevent the access to the electrical contacts when the latter are retracted inside the socket, this solution being arranged to mitigate the drawbacks of the prior art listed above.

### SUMMARY OF THE INVENTION

This aim is achieved by an electrical socket comprising:

a housing comprising at least one first opening,

at least one mobile assembly comprising at least one first electrical contact, arranged to display said first electrical contact in a direction of translation through said first opening between a first position in which the first electrical contact is retracted inside the socket and a second position in which the first electrical contact is outside the socket,

a first device for closing said first opening comprising a first flap arranged to pivot between a first position in which it at least partially closes said first opening when the first electrical contact is retracted inside the socket and a second position in which it opens the first opening to allow the first electrical contact to pass outside the socket,

at least one driving system arranged to transform a translational movement of the mobile assembly into a rotational movement of the flaps of the closing device,

the driving system comprising an arm linked on the one hand to the mobile assembly via a cam and cam-follower mechanism and on the other hand to said first flap and arranged to transform, by virtue of said cam and cam-follower mechanism, a translational movement of the mobile assembly into a rotational movement of the first flap of the first closing device.

Advantageously, the first closing device comprises a second flap cooperating with said first flap to close said first opening when the first electrical contact is retracted inside the socket.

Advantageously:

the housing comprises a second opening,

the mobile assembly comprises a second electrical contact arranged to be displaced in said direction of translation between a position retracted inside the socket and a position outside the socket through said second opening upon the displacement of the mobile assembly,

a second device for closing said second opening comprises a first flap and a second flap arranged to pivot between a first positon in which they at least partially close said second opening when the second electrical contact is retracted inside the socket and a second position in which they open the second opening to allow the second electrical contact to pass outside the socket.

Advantageously, the driving system comprises:

a first driving system arranged to simultaneously actuate the first flap of the first closing device and the first flap of the second closing device,

a second driving device arranged to simultaneously actuate the second flap of the first closing device and the second flap of the second closing device.

According to the invention, the first driving device comprises an arm composed of a main branch having an end bearing a cam follower, called first cam follower, and two secondary branches extending the main branch and each linked by their free end to the first flap of the first closing device and to the first flap of the second closing device.

According to the invention, the driving system comprises a cam, called first cam, secured to the mobile assembly and cooperating with the first driving device via said first cam follower.

Advantageously, the first cam comprises two consecutive rectilinear segments, a first rectilinear segment inclined in relation to said direction of translation and a second rectilinear segment produced in the direction of translation.

According to the invention, the second driving device comprises an arm composed of a main branch having an end bearing a cam follower, called second cam follower, and two secondary branches extending the main branch and each linked by their free end to the second flap of the first closing device and to the second flap of the second closing device.

Advantageously, the driving system comprises a cam, called second cam, secured to the mobile assembly and cooperating with the second driving device via said second cam follower. Advantageously, the second cam comprises two consecutive rectilinear segments, a first rectilinear segment inclined in relation to said direction of translation and a second rectilinear segment produced in the direction of translation.

According to the invention, each flap is pivotably mounted about an axis.

The invention relates also to an electrical socket assembly comprising:

a socket comprising at least two first electrical contacts linked to an electrical power supply circuit, a first magnetic part secured in movement to the two first electrical contacts, said first magnetic part being arranged to be displaced by magnetic effect between a first position in which the first electrical contacts are retracted inside the socket and a second position in which the first electrical contacts are outside the socket,

a plug intended to be coupled to the socket and comprising two second electrical contacts intended to be connected electrically to the two first electrical contacts when the latter are outside the socket and a second magnetic part arranged facing the first magnetic part when the plug is coupled to the socket to displace, by magnetic effect, the first magnetic part to its second position, driving the first electrical contacts towards the outside of the socket,

the socket being as defined above.

### BRIEF DESCRIPTION OF THE FIGURES

Other features and advantages will emerge from the following detailed description given in light of the attached drawings in which:

FIGS. 1A and 1B represent an example of an architecture of the electrical socket assembly of the invention, respectively with the plug separated from the socket and the plug mated on the socket,

FIGS. 2A to 2C illustrate the principle of operation of the closing device of the invention, respectively when the flaps are in closed position and the pin retracted, when the flaps are open and the pin in an intermediate position between its retracted position and its extracted position and when the flaps are open and the pin extracted from the socket.

FIG. 3 represents, in perspective, a driving device linked to the two first flaps,

FIG. 4 represents, in perspective, a driving device linked to the two second flaps,

FIG. 5 represents, in perspective, the cam mechanism cooperating with the two driving devices.

### DETAILED DESCRIPTION OF AT LEAST ONE EMBODIMENT

The invention is employed in the context of an electrical socket assembly operating by magnetic effect.

Referring to the attached figures, an electrical socket assembly of the invention comprises a socket 1 and an electrical plug 2 intended to be mated on the socket 1.

The socket 1 comprises a plastic housing 10 intended, for example, to be embedded in a wall. The socket 1 has a front face 11 against which the electrical plug is mated. The socket also comprises a mobile assembly 12 comprising two first electrical contacts, for example produced in the form of pins 120, 121. The two first electrical contacts are linked to an electrical power supply circuit 15 via conductive electrical wires. The mobile assembly 12 also comprises a first mobile magnetic part 13 arranged to be displaced in translation, in a direction of translation (X) at right angles to the front face 11, by magnetic effect, between a first position and a second position. A spring 14 positioned inside the housing 10 of the socket, for example fixed on the one hand to the housing 10 of the socket and on the other hand to the mobile assembly 12, is arranged to return the first magnetic part 13 into its first position when the magnetic effect necessary for extraction is no longer strong enough. In the first position of the first magnetic part 13, the pins 120, 121 are retracted inside the socket 1 and in the second position of the first magnetic part 13, the pins 120, 121 are protruding outside the socket 1, passing through its front face 11. In its second position, the mobile assembly comes into abutment, for example against a part of the housing 10.

The electrical plug 2 comprises, for its part, a plastic housing 20, having a front face 21 intended to come to bear against the front face 11 of the socket 1, defining a junction plane P (defined vertically in the attached figures) between the socket 1 and the plug 2. The plug 2 further comprises two second electrical contacts, for example two electrical tracks 220, 221 produced flush on its front face 21 and intended to come into electrical contact with the two pins 120, 121 of the socket 1. It also comprises a second magnetic part 23 fixed inside the housing and intended to attract the first magnetic part 13 when the plug 2 is offered up to the socket 1 in order to displace the mobile assembly and extract the pins 120, 121. Preferentially, the two electrical tracks 220, 221 are of circular form and positioned concentrically.

The first magnetic part and/or the second magnetic part comprises at least one permanent magnet so as to generate a magnetic flux between the two magnetic parts.

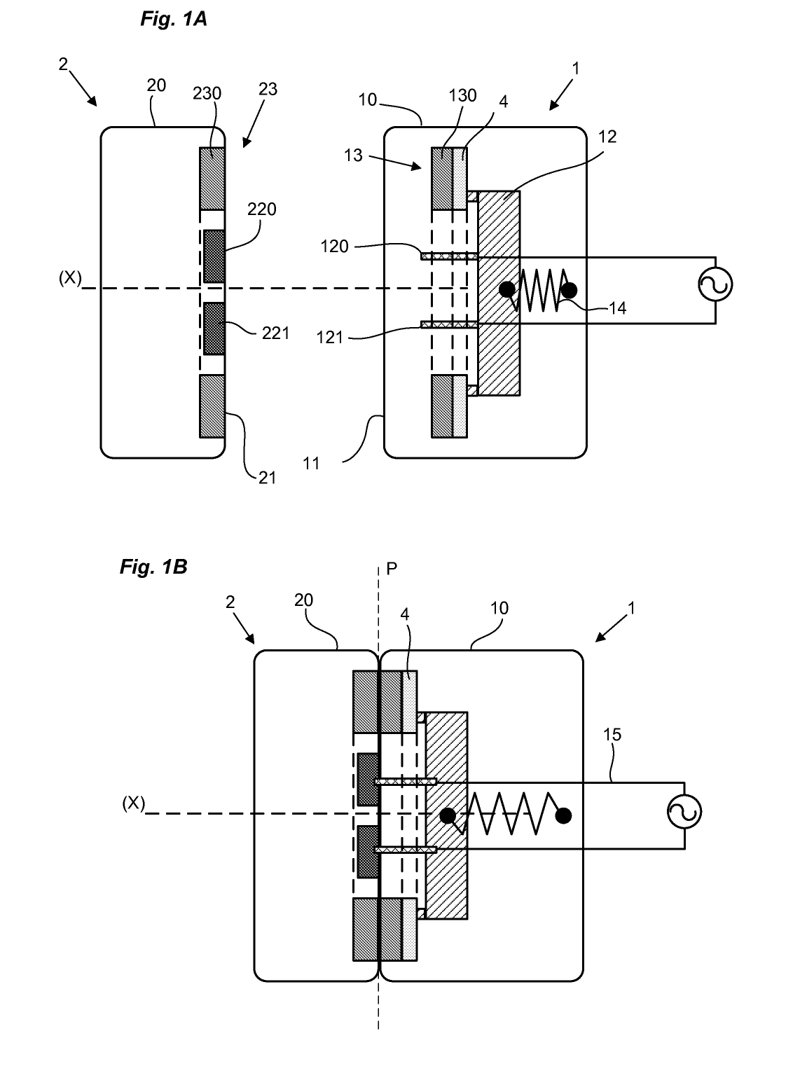

Different magnetic parts can thus be envisaged, such as those described in the applications EP2628213, EP2667459, . . . However, the latter are not the subject of the present application and it should be understood that the invention will be able to be adapted to any architecture provided that the latter provides for the presence of a magnetic flux that is at its maximum between the first magnetic part and the second magnetic part when the plug is mated on the socket and that reduces when the plug is moved away from the socket. Referring to the attached figures, the first magnetic part 13 comprises, for example, a permanent magnet 130 of annular form and the second magnetic part 23 comprises a permanent magnet 230 of annular form. In FIGS. 1A and 1B, the permanent magnet 130 is, for example, fixed onto a ferromagnetic piece 4. The permanent magnet 130 and the permanent magnet 230 are intended to be positioned coaxially when the plug 2 is offered up to the socket 1. When the plug 2 is facing the socket 1, the permanent magnet 130 and the permanent magnet 230 are arranged so as to each exhibit an air-gap surface parallel to the junction plane.

According to the invention, the socket also comprises, for each pin, a closing device intended to prevent access to the pin 120, 121 when the latter is retracted inside the socket 1. This closing device is composed of two flaps 160, 161-170, 171 for each pin.

For a pin, the two flaps are arranged to pivot conventionally, like the flaps mounted to close a window. Thus, the two flaps have the following characteristics:

in a first position, the two flaps are arranged to close the space reserved for the passage of the pin,

in their second position, the surface of the flaps is flush with the front face 11 of the socket,

in a second position, the two flaps are arranged to open the space reserved for the passage of the electrical pin,

each flap is mounted to pivot about an axis (denoted (a) and (b) in the figures),

for each pin, the two axes (a), (b) of the two flaps extend parallel to one another, at right angles to the direction of translation of the mobile assembly,

for each pin, the two flaps are arranged to open by pivoting about their axis in opposing directions of rotation.

With the socket comprising two pins 120, 121, the device comprises two pairs of flaps, denoted first pair of flaps (flaps 160, 161) and second pair of flaps (flaps 170, 171).

Each pair of flaps comprises a first flap 160, 170 arranged to pivot from the first position to the second position according to a first direction (S1) of rotation and a second flap 161, 171 arranged to pivot from the first position to the second position in a second direction of rotation (S2) opposite to the first direction of rotation (S1).

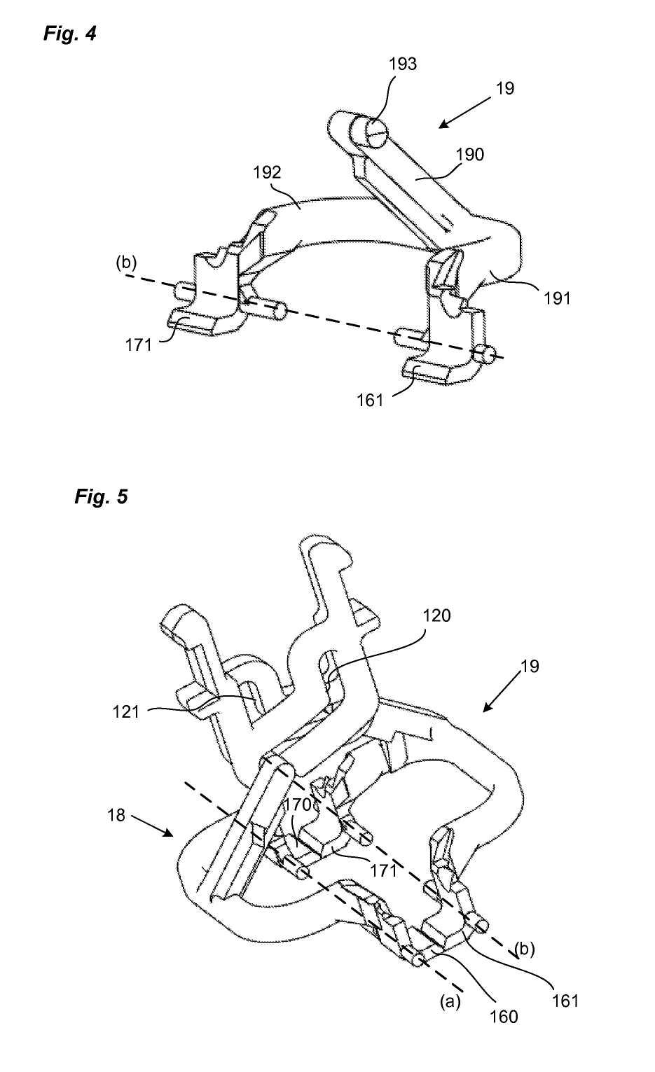

The closing device of the invention comprises two driving devices 18, 19 (FIGS. 3 and 4) actuated simultaneously by the movement of the mobile assembly and each arranged to simultaneously pivot two flaps, associated with a distinct pin. Thus, a first driving device 18 is arranged to simultaneously actuate the first flap 160 of the first pair and the first flap 170 of the second pair and a second driving device 19 is arranged to simultaneously actuate the second flap 161 of the first pair and the second flap 171 of the second pair. The first flap of the first pair and the first flap of the second pair are arranged to pivot simultaneously about the first axis of rotation (a). The second flap of the first pair and the second flap of the second pair are arranged to pivot simultaneously about the second axis of rotation (b), parallel to the first axis of rotation and at right angles to the direction of translation (X).

The following description relates interchangeably to the first driving device 18 (FIG. 3) or the second driving device 19 (FIG. 4), each employed to pivot two flaps simultaneously from their first position to their second position, and, conversely, to convert the translational movement of the mobile assembly into a rotational movement of the two flaps. This description of a driving device therefore applies to both first flaps 160, 170 actuated simultaneously or to both second flaps 161, 171 actuated simultaneously. Each driving device is linked rigidly to two flaps and thus takes the form of a single-piece part having a medium plane of symmetry at right angles to the pivoting axis (s) or (b) of its flaps.

Each driving device 18, 19 comprises a cam and cam follower mechanism arranged between the two associated flaps and the mobile assembly 12. The driving device 18, 19 comprises an arm having the following characteristics:

a main branch 180, 190 produced in a first plane and comprising a first free end bearing a slug 183, 193 performing the cam-follower function and intended to cooperate with the mobile assembly 12,

two secondary branches 181, 182, 191, 192 extending the main branch 180, 190 and forming two symmetrical offshoots in the form of a U, the two secondary branches being produced in a same second plane forming an acute angle with said first plane including the main branch,

the two secondary branches 181, 182, 191, 192 of the arm each ending with a rigid portion linked to the flap at its pivoting axis.

The mobile assembly 12 (visible in FIG. 5) for its part comprises two cams 120, 121, one cam for each driving device. The two cams 120, 121 are produced in parallel on the mobile assembly 12 and arranged inversely relative to one another so as to confer rotations in the two different directions S1, S2.

Each cam takes the form of a groove in which the slug 183, 193 produced at the end of the arm is positioned. Each groove comprises two consecutive rectilinear segments, hereinbelow denoted first segment 120a, 121a and second segment 120b, 121b.

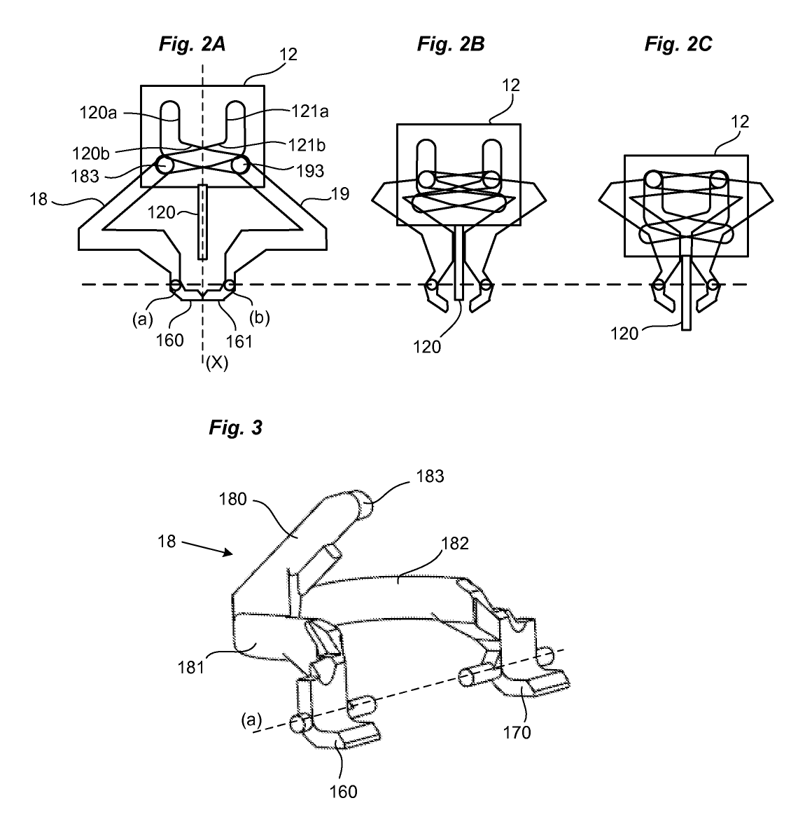

The first rectilinear segment 120a, 121a is situated in an inclined plane relative to the plane including an axis parallel to the direction of translation (X) of the mobile assembly 12. This first segment 120a, 120b is arranged to transform the translational movement of the mobile assembly 12 in pivoting movement of the two flaps (160, 170 for the first device and 161, 171 for the second device). For a pin, when the two slugs 183, 193 have each reached the end of this first segment, the flaps are in their second position but the pin is not yet fully extracted from the socket (FIG. 2B). Thus, the latter remains difficult to access even if the mechanism were to remain blocked in this configuration.

The second rectilinear segment 120b, 121b is produced according to an axis parallel to the direction of translation (X) of the mobile assembly 12. This second rectilinear segment is arranged to continue the extraction of the pins 120, 121 when the flaps have already been opened by virtue of the first segment.

FIG. 5 represents the complete architecture of the mechanism including the two cams, the two driving devices and the flap assembly.

The architecture which makes it possible to close the pins offers certain advantages, which include:

a flat front face is maintained when the flaps are closed,

a reliable two-stage operation, comprising, firstly, a mutual movement of opening of the flaps and of partial translation of the pins outward, and, secondly, a single movement of extraction of the pins to the point of abutment,

a reduced bulk linked in particular to the form of the driving devices and to the use of one and the same driving device for the simultaneous actuation of the two flaps.

1-12. (canceled)

13. An apparatus comprising an electrical socket, wherein said electrical socket comprises a housing, aa mobile assembly, a first closing device, and a driving system, wherein said housing comprises a first opening, wherein said mobile assembly comprises a first electrical contact, wherein said mobile assembly is configured to displace said first electrical contact in a translation direction through said opening between a first position and a second position, wherein, in said first position, said first electrical contact is retracted inside said electrical socket, wherein, in said second position, said first electrical contact is outside said electrical socket. wherein said first closing device is configured for closing said first opening, wherein said first closing device comprises a first flap, wherein said first flap is configured to pivot between first and second positions, wherein, in said first position, said first flap at least partially closes said first opening, wherein, in said second position, said first flap opens said first opening to allow said first electrical contact to pass outside said electrical socket, wherein said driving system comprises an arm, wherein a cam and a cam follower mechanism link said arm to said mobile assembly and to said first flap, and wherein said arm is configured to transform, using said cam and cam follower mechanism, a translation of said mobile mechanism into a rotation of said first flap.

14. The apparatus of claim 13, wherein said first closing device further comprises a second flap, wherein said second flap cooperates with said first flap to close said first opening when said first electrical contact is retracted inside said electrical socket.

15. The apparatus of claim 14, further comprising a second closing device, wherein said housing further comprises a second opening, wherein said mobile assembly further comprises a second electrical contact, wherein said second electrical contact is configured to be displaced in said direction of translation between a position retracted inside said electrical socket and a position outside said electrical socket through said second opening upon displacement of said mobile assembly, wherein said second closing device is configured for closing said second opening, and wherein said second closing device comprises a first flap and a second flap arranged to pivot between a first position in which said first and second flaps at least partially close said second opening when said second electrical contact is retracted inside said electrical socket and a second position in which said first and second flaps open said second opening to allow said second electrical contact to pass outside of said electrical socket.

16. The apparatus of claim 15, wherein said driving system comprises first and second driving devices, wherein said first driving device is configured to simultaneously actuate said first flap of said first closing device and said first flap of said second closing device, and wherein said second driving device is configured to simultaneously actuate said second flap of said first closing device and said second flap of said second closing device.

17. The apparatus of claim 16, wherein said first driving device comprises an arm, wherein said arm comprises a main branch and two secondary branches, wherein said main branch has an end bearing a first cam-follower, wherein said two secondary branches extend said main branch, and wherein said secondary branches are each linked by respective free ends thereof to said first flap of said first closing device and to said first flap of said second closing device.

18. The apparatus of claim 17, wherein said driving system comprises a first cam secured to said mobile assembly and wherein said first cam cooperates with said first driving device via said first cam follower.

19. The apparatus of claim 18, wherein said first cam comprises first and second rectilinear segments, wherein said first and second rectilinear segments are consecutive, wherein said first rectilinear segment is inclined in relation to said direction of translation and wherein said second rectilinear segment is produced in said direction of translation.

20. The apparatus of claim 16, wherein said second driving device comprises an arm composed of a main branch having an end bearing a cam follower, called second cam follower, and two secondary branches extending said main branch and each linked by their free end to said second flap of said first closing device and to said second flap of said second closing device.

21. The apparatus of claim 20, wherein said driving system further comprises a second cam, wherein said second cam is secured to said mobile assembly, wherein said second cam is configured to cooperate with said second driving device via said second cam follower.

22. The apparatus of claim 21, wherein said second cam comprises two first and second rectilinear segments, wherein said first and second rectilinear segments are consecutive rectilinear segments, wherein said first rectilinear segment is inclined in relation to said direction of translation, and wherein said second rectilinear segment is produced in said direction of translation.

23. The apparatus of claim 16, wherein each of said first flaps is pivotably mounted about an axis thereof.

24. The apparatus of claim 13, further comprising an electrical-socket assembly, wherein electrical-socket assembly comprises a plug and said electrical socket, wherein said electrical socket comprises at first electrical contacts and a first magnetic part, wherein said first electrical contacts are linked to an electrical-power supply-circuit, wherein said first magnetic part is secured in movement to said first electrical contacts, wherein said first magnetic part is configured to be displaced by magnetic force between first position and second positions thereof, wherein, in said first position, said first electrical contacts are retracted inside said socket, wherein, in said second position, said first electrical contacts are outside said socket, wherein said plug is configured to be coupled to said electrical socket, wherein said plug comprises two second electrical contacts configured to be electrically connected to said first electrical contacts when said first electrical contacts are outside said socket and a second magnetic part arranged facing said first magnetic part when said plug is coupled to said socket to displace, by magnetic effect, said first magnetic part to its second position, driving said first electrical contacts towards said outside of said socket.
